(19) United States
(12) Patent Application Publication
(10) Pub. No.: US 2025/0128738 A1
(43) Pub. Date: Apr. 24, 2025

(54) TRAVEL ASSISTANCE DEVICE AND TRAVEL ASSISTANCE METHOD

(71) Applicant: Hitachi Astemo, Ltd., Hitachinaka-shi, Ibaraki (JP)

(72) Inventors: Yusuke NOMA, Hitachinaka-shi, Ibaraki (JP); Keiichiro NAGATSUKA, Hitachinaka-shi, Ibaraki (JP); Hitoshi HAYAKAWA, Tokyo (JP)

(73) Assignee: Hitachi Astemo, Ltd., Hitachinaka-shi, Ibaraki (JP)

(21) Appl. No.: 18/834,178

(22) PCT Filed: Feb. 24, 2022
(86) PCT No.: PCT/JP2022/007602

§ 371 Date: Jul. 29, 2024

(51) Int. Cl. B60W 60/00; B60W 50/14

(52) U.S. Cl. CPC B60W 60/0053; B60W 50/14; B60W 60/001; B60W 2554/4041

(57) ABSTRACT

A travel assistance device includes: a detection result storage unit that stores a detection result of an external sensor installed in a host vehicle; a moving object recognition unit that recognizes a surrounding moving object based on a detection result of the external sensor; a route storage unit that stores a route along which the host vehicle has moved based on vehicle information acquired by a vehicle sensor installed in the host vehicle; an initial stop position determination unit that determines an initial position at which the host vehicle has stopped before starting, based on the detection result stored in the detection result storage unit; and a vehicle control unit that stops the host vehicle based on a recognition result of the moving object recognition unit after the host vehicle starts from the initial position. The detection result storage unit stores at least the initial position and the detection result on the route. The vehicle control unit controls movement on the route from a stop position where the host vehicle is stopped to the initial position based on a detection result of the external sensor at a current position of the host vehicle and a detection result of the external sensor stored in the detection result storage unit.

### TECHNICAL FIELD

The present invention relates to a travel assistance device and a travel assistance method for assisting traveling of a vehicle using a sensing result of an external sensor.

### BACKGROUND ART

Vehicle control technologies such as adaptive cruise control (ACC), an advanced emergency braking system (AEBS), and a lane keeping assist system (LKAS) are known as technical elements of a driving assistance system and an automatic driving system using a sensing result of an external sensor. In the case of using these vehicle control technologies, the environment around the host vehicle is constantly analyzed and monitored based on the detection result of the external sensor to perform traveling to follow a preceding vehicle, activating emergency braking, and steering control so as not to stray from the traveling lane.

As another type of vehicle control technology using a sensing result of an external sensor, PTL 1 discloses a vehicle control technology for returning a vehicle to a vehicle position at a time point specified by tracing back accumulated locus information. For example, the abstract of PTL 1 describes “During driving of a vehicle, locus information indicating the locus is accumulated in a locus information storage unit 20a. When a driver performs a return operation, control is performed to move the vehicle to a position at a time point specified by tracing back the recorded locus information. The driver can perform manual driving again from the position.”, and paragraph 0022 of the same document describes “The return switch 931 is a switch for requesting or instructing return. When the driver presses it, the control unit 2 returns the vehicle to a state at a predetermined time point or a specified time point or a selected time point. The state to be returned may be determined in advance, for example, or may be selected by the driver each time the operation is performed. For example, a plurality of return switches may be provided, and the selection may be performed according to the operated switch, or may be determined by the operation time.”.

### CITATION LIST

### Patent Literature

PTL 1: JP 2020-75655 A

### SUMMARY OF INVENTION

### Technical Problem

When a host vehicle stops on the path of another approaching vehicle due to brake operation by the driver or activation of AEBS at the time of exiting from a parking lot or entering an intersection, the host vehicle hinders traveling of the other vehicle.

In such a case, it is also possible to autonomously move the host vehicle to a position that does not hinder the travel of the other vehicle by applying the technology of PTL 1. However, as described in paragraph 0035 of PTL 1 as “Note that since the procedure of FIG. 4, particularly from S401 onward, is controlled by automatic driving, monitoring of the external environment by various sensors such as a radar, a rider, a camera, and a sonar is performed without interruption during this period, and if it is determined that there is a risk of collision, the procedure of FIG. 3 is interrupted and the vehicle stops.”, when the technology of PTL 1 is used, it is necessary to continue to determine the presence or absence of the possibility of collision using the sensing results of various sensors while the host vehicle is autonomously moved to a position that does not hinder the travel of the other vehicle. That is, when the technique of PTL 1 is used, there is a problem that a vehicle control system for autonomously moving a host vehicle stopped on a course of another vehicle to a predetermined position becomes complicated.

Therefore, an object of the present invention is to provide a travel assistance device and a travel assistance method capable of safely and autonomously moving a host vehicle from a position that obstructs the travel of another moving object to a position that does not obstruct the travel based on a simpler determination than the determination of the possibility of collision.

### Solution to Problem

In order to solve the above problems, a travel assistance device according to the present invention includes: a detection result storage unit that stores a detection result of an external sensor installed in a host vehicle; a moving object recognition unit that recognizes a surrounding moving object based on a detection result of the external sensor; a route storage unit that stores a route along which the host vehicle has moved based on vehicle information acquired by a vehicle sensor installed in the host vehicle; an initial stop position determination unit that determines an initial position at which the host vehicle has stopped before starting, based on the detection result stored in the detection result storage unit; and a vehicle control unit that stops the host vehicle based on a recognition result of the moving object recognition unit after the host vehicle starts from the initial position. The detection result storage unit stores at least the initial position and the detection result on the route. The vehicle control unit controls movement on the route from a stop position where the host vehicle is stopped to the initial position based on a detection result of the external sensor at a current position of the host vehicle and a detection result of the external sensor stored in the detection result storage unit.

### Advantageous Effects of Invention

According to the travel assistance device and the travel assistance method of the present invention, it is possible to safely and autonomously move the host vehicle from a position that hinders the traveling of the other moving object to a position that does not hinder the traveling of the other moving object on the basis of a simpler determination than the determination of the possibility of collision.

### BRIEF DESCRIPTION OF DRAWINGS

FIG. 1 is a functional block diagram of a travel assistance system according to a first embodiment.

FIG. 2 is an explanatory diagram exemplifying a use case of the first embodiment (when an ultrasonic sensor is used).

FIG. 3 is an explanatory diagram exemplifying a use case of the first embodiment (when a radar sensor is used).

FIG. 4 is an explanatory diagram exemplifying an example of a use case of the first embodiment (when a camera sensor is used).

FIG. 5 is an explanatory diagram exemplifying a use case of the first embodiment (when autonomous movement control is interrupted).

FIG. 6 is a flowchart illustrating a processing procedure of the first embodiment.

FIG. 7 is a flowchart illustrating a processing procedure of step S13 in FIG. 6.

FIG. 8 is an explanatory diagram exemplifying a use case of a second embodiment.

### DESCRIPTION OF EMBODIMENTS

Hereinafter, an embodiment of a travel assistance device of the present invention will be described with reference to the drawings. In the drawings, objects to which the same numbers are assigned represent the same components, and redundant description will be omitted. Note that, although application to a driving assistance system will be described as an example in any of the embodiments, application to an automatic driving system is also possible, and a similar effect can be obtained.

### First Embodiment

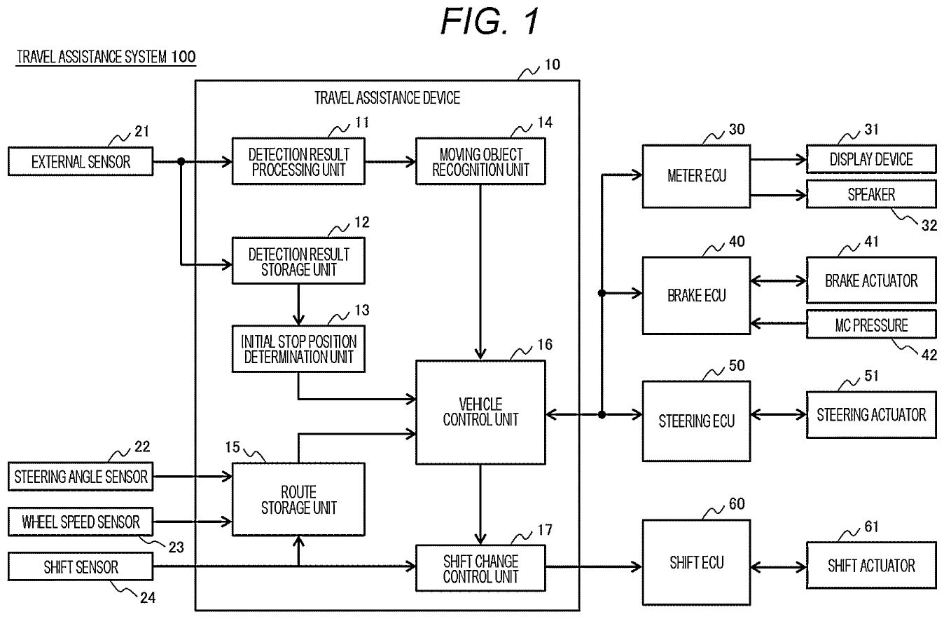

First, a travel assistance device 10 according to a first embodiment of the present invention will be described with reference to FIGS. 1 to 7.

FIG. 1 is a functional block diagram schematically illustrating an overall configuration of a travel assistance system 100 including a travel assistance device 10 of the present embodiment. As illustrated herein, an external sensor 21, a steering angle sensor 22, a wheel speed sensor 23, and a shift sensor 24 are arranged on the input side of the travel assistance device 10, and a meter ECU 30, a brake ECU 40, a steering ECU 50, and a shift ECU 60 are arranged on the output side.

The travel assistance device 10 is a device for performing vehicle control from storage of an output result of the external sensor 21 necessary for a host vehicle 1 to realize travel assistance and storage of a travel route based on output results of the steering angle sensor 22 and the wheel speed sensor 23, and includes a detection result processing unit 11, a detection result storage unit 12, an initial stop position determination unit 13, a moving object recognition unit 14, a route storage unit 15, a vehicle control unit 16, and a shift change control unit 17. Specifically, the travel assistance device 10 is a computer including an arithmetic device such as a CPU, a storage device such as a semiconductor memory, and hardware such as a communication device. Then, the arithmetic device executes a predetermined program to realize each functional unit such as the detection result processing unit 11 described above, but hereinafter, such a well-known technique will be appropriately omitted.

The external sensor 21 is a sensor necessary for the travel assistance device 10 to recognize a moving object (traveling vehicle, cyclist, pedestrian, and the like) or a stationary object (stopped vehicle, wall, electric pole, etc.) around the host vehicle, and is specifically a camera sensor such as an ultrasonic sensor using a sound wave, a radar sensor using a millimeter wave or a laser, or a monocular camera or a stereo camera using an image element.

The steering angle sensor 22, the wheel speed sensor 23, and the shift sensor 24 are sensors that generate information of the steering angle, the wheel speed, and the shift, and are used, in the present embodiment, when a traveling locus of the host vehicle 1 is calculated or the host vehicle 1 autonomously moves to an initial position.

The meter ECU 30 is a device that controls a display device 31 and a speaker 32 in accordance with a voice output request or a meter display request obtained from the vehicle control unit 16 to warn or prompt the user to perform control.

The brake ECU 40 is a device that controls a brake actuator 41 according to a brake braking request obtained from the vehicle control unit 16 and the hydraulic pressure information obtained from an MC pressure 42 to stop the vehicle.

The steering ECU 50 is a device that controls a steering actuator 51 in accordance with a steering operation request obtained from the vehicle control unit 16 to turn the host vehicle 1.

The shift ECU 60 is a device that controls a shift actuator 61 in accordance with a shift change request obtained from the shift change control unit 17 to automatically change the shift.

### Travel Assistance Device 10

Next, each part of the travel assistance device 10 of the present embodiment will be outlined.

The detection result processing unit 11 analyzes the surrounding environment of the host vehicle 1 on the basis of information on the surrounding environment (information on moving objects (traveling vehicle, cyclist, pedestrian, and the like) and stationary objects (stopped vehicle, wall, electric pole, etc.)) obtained from the external sensor 21 mounted on the host vehicle 1.

The detection result storage unit 12 cumulatively stores the surrounding environment information obtained from the external sensor 21 until a predetermined time (for example, 5 minutes) elapses from the start of the host vehicle 1 or until the manual brake or the automatic brake is activated after the start of the host vehicle 1.

The initial stop position determination unit 13 determines whether the autonomous movement control to the original position by the travel assistance described later is completed based on the surrounding environment information before the host vehicle 1 starts.

The moving object recognition unit 14 recognizes a moving object (vehicle, cyclist, pedestrian) approaching the host vehicle 1 on the basis of information that can be recognized by the host vehicle 1 obtained from the detection result processing unit 11, and also recognizes whether the host vehicle 1 remains on a route of the approaching moving object.

The route storage unit 15 cumulatively stores sensor information (steering operation) obtained from the steering angle sensor 22, sensor information (vehicle speed) obtained from the wheel speed sensor 23, and sensor information (vehicle traveling direction) obtained from the shift sensor 24. Since the route of the host vehicle 1 from the initial position to the current position can be calculated from the various information stored in the route storage unit 15, the route obtained from the stored sensor information can be used as a route when the host vehicle 1 autonomously moves from the stop position to the initial position by tracing the route in the reverse direction.

When the moving object recognition unit 14 recognizes a moving object, the vehicle control unit 16 controls various ECUs to follow the route obtained from the route storage unit 15 until the initial stop position determination unit 13 determines that the movement to the initial position is completed after appropriately operating the automatic brake.

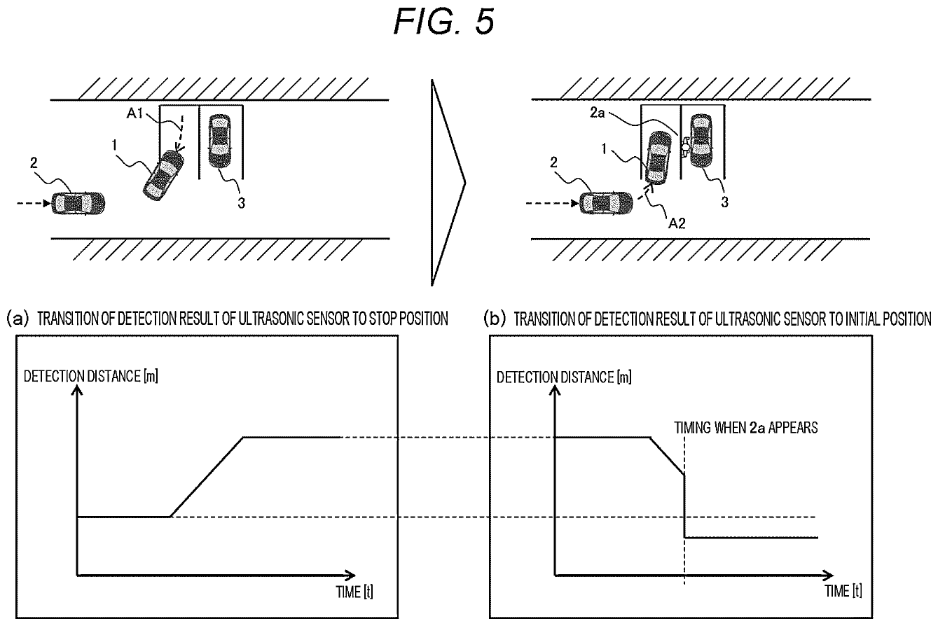

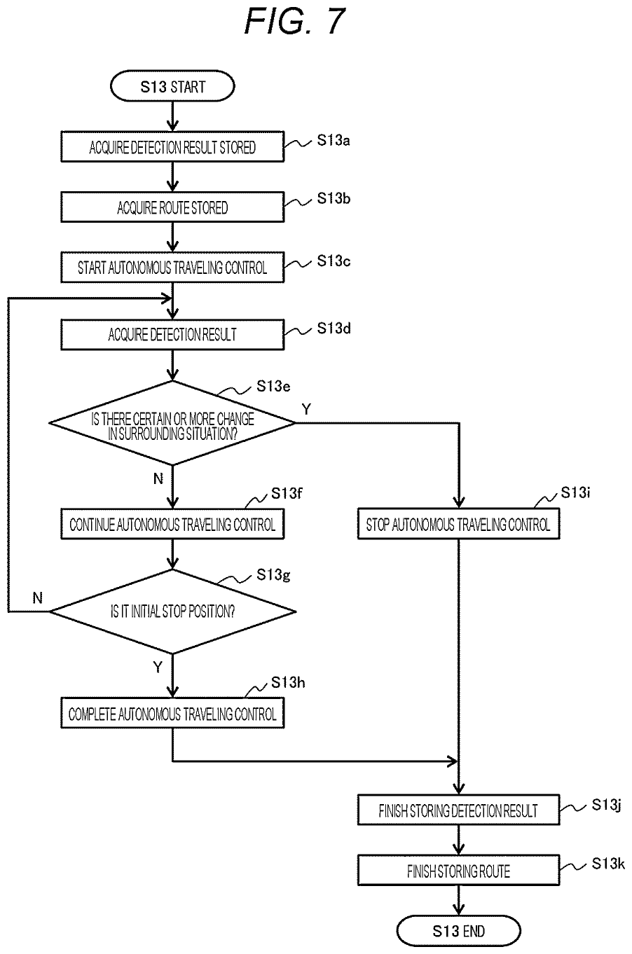

Note that, in a case where there is a certain difference (for example, an error of 10% or more) between the cumulative storage of the detection result storage unit 12 and the output of the external sensor 21 acquired during the movement to the initial position, if it is determined that there is a change in the route to the initial position and it is not safe, the vehicle control unit 16 interrupts the autonomous movement control, and the host vehicle 1 stops on the spot. Details of this control will be described with reference to FIGS. 5 and 7.

On the basis of the traveling direction information obtained from the shift sensor 24, since the movement to the initial position is opposite to the current traveling direction (for example, in the case of a D range, an R range is used, and in the case of the R range, the D range is used), the shift change control unit 17 automatically switches the traveling direction by a shift-by-wire or the like. When the movement of the vehicle to the initial stop position is completed or the vehicle is interrupted, the shift of the host vehicle 1 is brought into a neutral state or a parking state to bring the host vehicle 1 into a safe state.

### Specific Use Case

Next, the control by the travel assistance device 10 will be described for each type of the external sensor 21, taking, as an example, a situation where the host vehicle 1 stops to avoid collision with a moving object 2 approaching the host vehicle 1 after the start of the host vehicle 1, and the host vehicle 1 autonomously moves from the stop position to the initial position.

### Case where External Sensor 21 is Ultrasonic Sensor

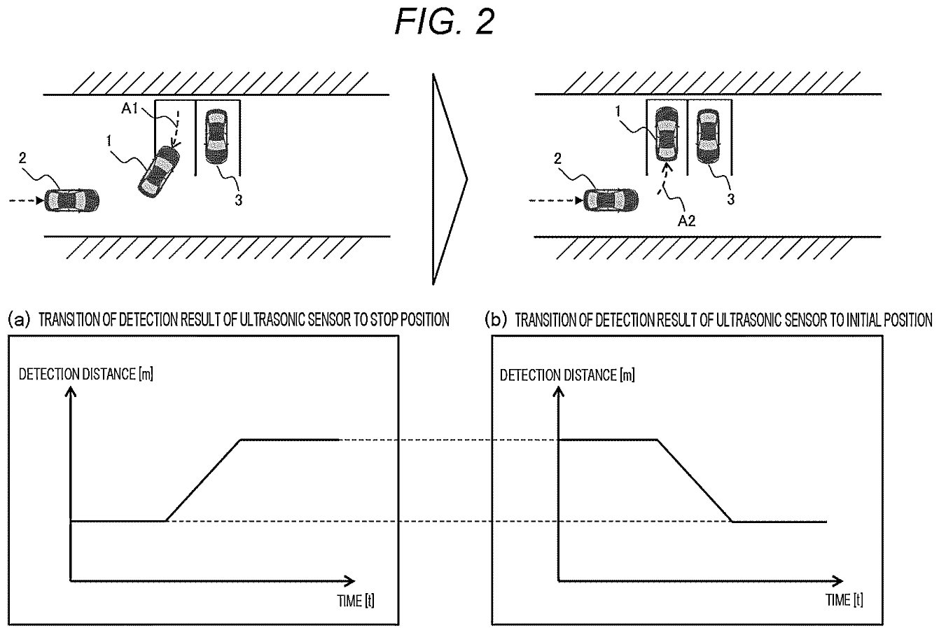

FIG. 2 illustrates an example of driving assistance in a case where an ultrasonic sensor is used as the external sensor 21. The upper left diagram of FIG. 2 illustrates a situation where the host vehicle 1 is exiting the parking slot while moving backward on the route (forward route) indicated by the arrow A1, and a position where the host vehicle 1 stops before exiting the parking slot is defined as an initial position. The moving object 2 is a traveling vehicle approaching from the left rear of the host vehicle 1, and a stationary object 3 is a stopped vehicle parked on the right side of the host vehicle 1. Note that, in FIG. 2, a traveling vehicle is exemplified as an example of the moving object 2, but the moving object 2 may be a cyclist, a pedestrian, or the like, and the stationary object 3 is not limited to a stopped vehicle, and may be a wall, a bicycle (on which no person rides), or the like.

At this time, in the host vehicle 1, the moving object 2 approaching from the side surface is detected by the external sensor 21 (ultrasonic sensor) or recognized by the driver, and when it is determined that there is a risk of collision, the automatic brake or the manual brake is operated. As a result of operating the brake, the host vehicle 1 has stopped at the position illustrated in the upper left diagram of FIG. 2, that is, on the route of the moving object 2, and thus the travel assistance device 10 performs control to autonomously move the host vehicle 1 to the initial position on the route (backward route) indicated by the arrow A2 in the upper right diagram of FIG. 2.

During the autonomous movement on the backward route, the travel assistance device 10 executes the vehicle control of autonomously moving to the initial position based on the stored information of the output result of the external sensor 21 from the initial position to the timing when the brake is operated and the stored information of the output results of the steering angle sensor 22 and the wheel speed sensor 23.

The output of the external sensor 21 stored in the detection result storage unit 12 is the output of the external sensor 21 on the front side of the host vehicle 1 in a case where the host vehicle 1 exits the parking slot in a backward direction as illustrated in the upper left diagram of FIG. 2, and is the output of the external sensor 21 on the rear side of the host vehicle 1 in a case where the host vehicle exits the parking slot in a forward direction (not illustrated). These outputs are used to determine whether a difference has occurred in the surrounding environment of the initial position.

In addition, with respect to the output results of the steering angle sensor 22 and the wheel speed sensor 23 stored in the route storage unit 15, it is possible to autonomously move the host vehicle 1 to the initial position by reversely following the timing from the timing when the brake is operated to the timing when the host vehicle 1 is at the initial position. Note that the route storage unit 15 may include a traveling direction associated with time or an event in addition to the information of the steering angle sensor 22 and the wheel speed sensor 23. At the time of transition to the movement control, guidance is performed by sound or meter display, and the driver may select whether to manually move to the initial stop position, or may automatically return to the initial stop position after the stop.

As illustrated in the upper right diagram of FIG. 2, when the autonomous movement control (see the arrow A2) of the backward route from the stop position to the initial position starts, the vehicle control unit 16 controls the brake ECU 40, the steering ECU 50, and the shift ECU 60 to move from the stop position to the initial position based on the sensor output (corresponding to the route of the arrow A1) recorded in the route storage unit 15. Then, during the autonomous movement, if an error between the output result (that is, the current environment around the initial position) of the external sensor 21 and the output result (that is, the environment around the initial position at the time of departure) of the external sensor 21 at the time of departure stored in the detection result storage unit 12 is within a certain range (for example, the error is less than 10%), the vehicle control unit 16 assumes that there is no large change in the environment around the initial position, and continues the autonomous movement control until the vehicle moves to the initial position.

A graph (a) at the lower left of FIG. 2 shows distance information to the front wall detected by the ultrasonic sensor (external sensor 21) installed on the front side of the host vehicle 1 during traveling in the forward route (arrow A1) from the initial position until the brake is operated. As illustrated here, while the host vehicle 1 is at the initial position, the distance to the front wall is short, but when the host vehicle 1 starts to move backward, the distance to the front wall gradually increases, and when the host vehicle 1 stops to avoid collision with the moving object 2, the distance to the front wall becomes constant.

On the other hand, a graph (b) at the lower right of FIG. 2 shows distance information detected by the ultrasonic sensor (external sensor 21) installed on the front side of the host vehicle 1 during the autonomous movement on the backward route (arrow A2) from the stop position to the initial position after the brake operation. In a case where the host vehicle 1 autonomously moves on the backward route (arrow A2) going back the forward route (arrow A1), if the surrounding environment has not changed, the detection result of the ultrasonic sensor (external sensor 21) should change as in the graph (b) obtained by horizontally inverting the time axis of the graph (a) detected on the forward route (arrow A1).

Therefore, when the detection result (in the example of FIG. 2, the graph (b) is a detection result obtained by horizontally inverting graph (a)) opposite to that of the forward route is obtained at the time of autonomous movement to the initial position based on the information obtained from the route storage unit 15, the vehicle control unit 16 can determine that the surrounding environment of the initial position has not changed, and can autonomously move the host vehicle 1 to the initial position while confirming safety.

Thereafter, when determining that the movement to the initial position has been completed, the vehicle control unit 16 controls each ECU to stop at the initial stop position and change the transmission to the neutral or parking state. The vehicle control unit 16 also deletes the information stored in the route storage unit 15 and the detection result storage unit 12. Accordingly, when the host vehicle 1 exits the parking slot again, new information is stored in the route storage unit 15 and the detection result storage unit 12, and in a case where the host vehicle 1 needs to autonomously move to the initial position again, the autonomous movement control to the initial position is performed using the newly stored information.

### Case where External Sensor 21 is Radar Sensor

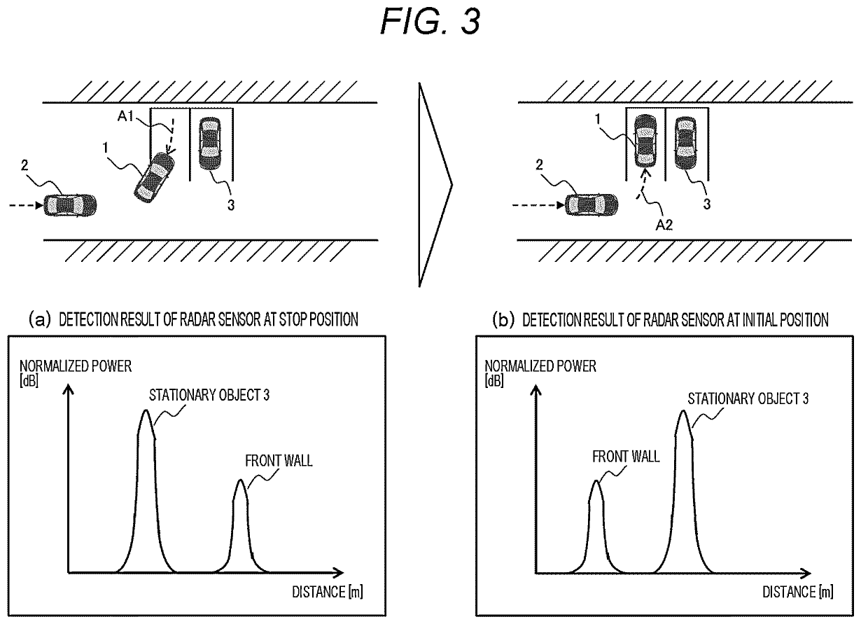

FIG. 3 illustrates an example of driving assistance in a case where a radar sensor is used as the external sensor 21. The control method of the host vehicle 1 is similar to the contents described with reference to FIG. 2, but in the case of a radar sensor, an RF signal is converted into an IF signal, and the IF signal is Fourier-transformed to detect a distance to an object. The waveform after the Fourier transform for detecting the distance is used to determine whether there is a difference in the surrounding environment. As an advantage of using the waveform after the Fourier transform, in the present invention in which the change in the surrounding environment is determined only by the change in the waveform after the Fourier transform, it is possible to incorporate the system as a simple method, and it is not necessary to finely analyze the surrounding environment of the host vehicle 1 for determining the possibility of collision.

A graph (a) at the lower left of FIG. 3 shows detection distance detected by the radar sensor (external sensor 21) at the time of brake operation, and a graph (b) at the lower right of FIG. 3 is a detection distance detected by the radar sensor at an initial position. Therefore, the travel assistance device 10 compares the transition in which the graph (b) changes to the graph (a) in the forward route (arrow A1) and the transition in which the graph (a) changes to the graph (b) in the backward route (arrow A2), and if both are in a substantially reverse relationship, it is regarded that there is no large change in the environment around the initial position, and the autonomous movement control is continued until the vehicle moves to the initial position.

### Case where External Sensor 21 is Camera Sensor

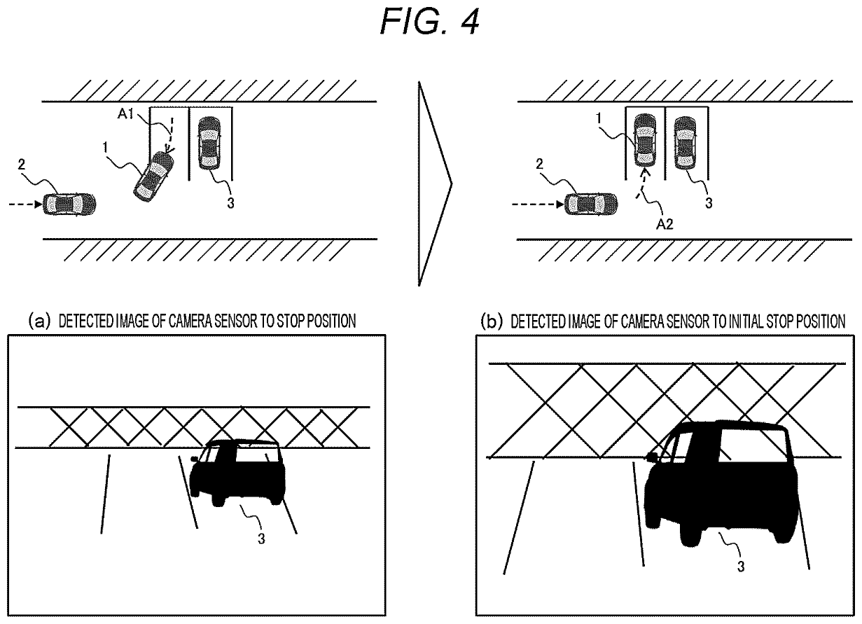

FIG. 4 illustrates an example of driving assistance in a case where a camera sensor is used as the external sensor 21. The control method of the vehicle is similar to the contents described with reference to FIGS. 2 and 3, but the difference is detected by storing for each frame in the case of the camera sensor. Similarly to the advantage of the radar sensor, it is not necessary to perform detailed analysis by using the raw data output from the camera sensor, and the system can be incorporated in a simple method. The method of detecting the difference may be for each frame or a feature amount.

An image (a) at the lower left of FIG. 4 is one frame of an image in the surrounding environment detected by the camera sensor (external sensor 21) on the forward route (arrow A1), and an image (b) at the lower right of FIG. 4 is one frame of an image in the surrounding environment detected by the camera sensor on the backward route (arrow A2).

Also in this case, if the surrounding environment has not changed, the transition in which the difference between the detection images changes in the forward route (arrow A1) and the transition in which the difference between the detection images changes in the backward route (arrow A2) have opposite relationships. Therefore, it is possible to safely move the host vehicle 1 to the initial position by comparing the transitions of the difference changes. After the vehicle stops at the initial stop position, information in the route storage unit 15 and the detection result storage unit 12 is deleted.

### Case where Autonomous Movement to Initial Position is Interrupted

Next, the operation of the travel assistance device 10 in a case where the detection result of the external sensor 21 in the forward route (arrow A1) and the detection result of the external sensor 21 in the backward route (arrow A2) are not in a normal relationship as illustrated in FIGS. 2 to 4, and there is a change in the surrounding environment at the initial position will be described. Note that, here, a case where the external sensor 21 is an ultrasonic sensor (see FIG. 2) is exemplified, but the same process can be performed also in a case where the external sensor 21 is a radar sensor (see FIG. 3) or a camera sensor (see FIG. 4).

FIG. 5 illustrates an example of a case where the driving assistance of the vehicle according to the present embodiment is interrupted when the ultrasonic sensor is used. As illustrated in FIG. 5, the process is the same as that in FIG. 2 until the host vehicle 1 operates the brake in response to the moving object 2 approaching from the side when the host vehicle 1 tries to exit the parking slot in a backward direction from the stop state.

When the brake is operated, the host vehicle 1 performs the movement control to the initial stop position as illustrated in the upper right diagram of FIG. 5. However, in this example, since a moving object 2a suddenly appears (for example, in a case where a person gets off from the stationary object 3, or the like), a large difference appears between the distance information in the surrounding environment detected by the ultrasonic sensor in the forward route (arrow A1) illustrated in the graph (a) at the lower left of FIG. 5 and the distance information in the surrounding environment detected by the ultrasonic sensor in the backward route (arrow A2) illustrated in the graph (b) at the lower right of FIG. 5. Therefore, the autonomous movement control of the host vehicle 1 is interrupted and the vehicle is stopped at the timing when the difference appears regardless of the presence or absence of collision with the moving object 2a. After the vehicle stops, the shift of the host vehicle 1 is put into neutral or parking to be in a safe state, and information in the route storage unit 15 and the detection result storage unit 12 is erased.

As described above, in the present embodiment, since the host vehicle 1 is stopped in a case where a change in the surrounding environment of the host vehicle 1 is detected by comparing the past output and the current output of the external sensor 21, it is possible to safely stop the host vehicle 1 without performing advanced determination such as determining whether there is a possibility of collision between the host vehicle 1 and the moving object 2a.

### Flowchart

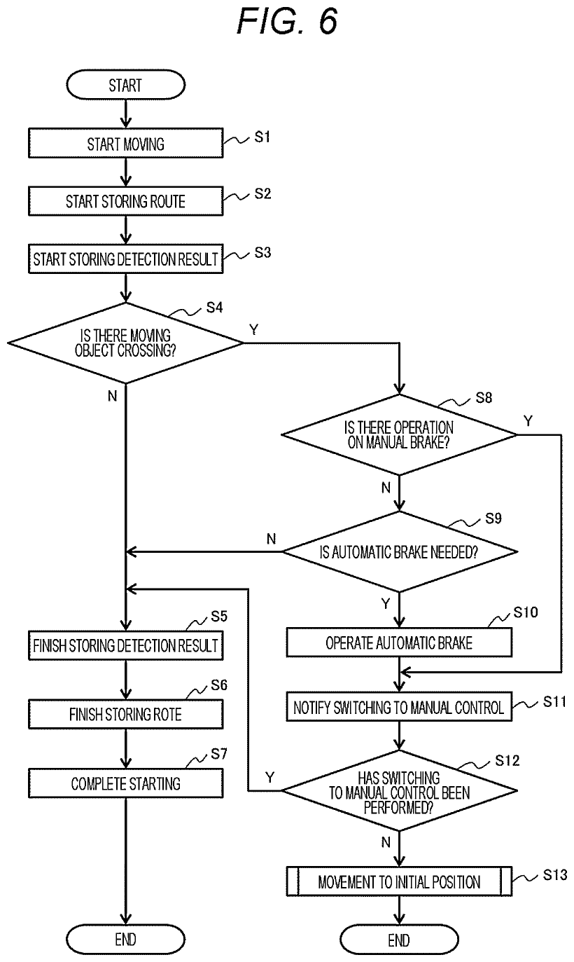

Next, a control procedure used in the use cases of FIGS. 2 to 5 will be described with reference to flowcharts of FIGS. 6 and 7.

First, in step S1 of FIG. 6, the host vehicle 1 stopped at the initial position starts. Note that the start may be performed by manual control or automatic control.

In step S2, the route storage unit 15 stores the host vehicle route (forward route) after the start. Note that the host vehicle route stored here is actually the outputs of the steering angle sensor 22, the wheel speed sensor 23, and the shift sensor 24.

In step S3, the detection result storage unit 12 stores the detection result of an external recognition sensor 21 during the movement in the forward route (arrow A1).

In step S4, the moving object recognition unit 14 determines whether there is a moving object that crosses the rear side or the front side of the host vehicle 1 on the basis of the information obtained from the detection result of the external recognition sensor 21. Then, in a case where there is no moving object to cross, the process proceeds to step S5, and in a case where there is a moving object to cross, the process proceeds to step S8.

In a case where there is no moving object to cross, the detection result storage is finished in step S5. In addition, in step S6, the route storage is also ended. Then, in step S7, it is determined that the start has been normally completed, and the travel assistance is finished. The determination that the start is completed may be made when the R range is changed to the D range at the time of exiting the parking slot in a backward direction, or when, for example, five minutes have elapsed from the start. When the determination is made by time, it is in balance with the amount that can be stored.

On the other hand, when there is a moving object to cross, in step S8, the vehicle control unit 16 determines whether the manual brake operation is performed based on the output of the brake ECU 40. In a case where the manual brake operation is performed, the process proceeds to step S11, and in a case where the manual brake operation is not performed, the process proceeds to step S9.

In a case where the manual brake operation is performed, in step S11, the vehicle control unit 16 and the meter ECU 30 display a notification for switching the manual control by a buzzer or meter to prompt the driver to determine whether to move to the initial stop position.

On the other hand, in a case where the manual brake operation is not performed, in step S9, the vehicle control unit 16 determines whether the moving object 2 is approaching to such an extent that the automatic brake needs to be operated. In a case where the automatic brake is required, the process proceeds to step S10, and when the automatic brake is not required, the process proceeds to step S5.

In a case where the moving object 2 traversing is present at a distance not requiring the automatic brake, the control to move to the initial stop position is not necessary, and thus, in step S5, the storage of the recognition result and the storage of the route are deleted assuming that the start is completed. Thereafter, the travel assistance is finished.

On the other hand, in a case where the moving object 2 traversing approaches within the distance requiring the automatic brake, the vehicle control unit 16 and the brake ECU 40 operate the automatic brake in step S10. Thereafter, in step S11, the vehicle control unit 16 and the meter ECU 30 display a notification for switching the manual control by the buzzer or meter to prompt the driver to determine whether to move to the initial stop position.

In step S12, the vehicle control unit 16 determines whether switching to the manual control has been performed. Then, in a case where the control is switched to the manual control, the process proceeds to step S5. In a case where the control is not switched to the manual control, that is, in a case where it is necessary to return to the initial position following the forward route (arrow A1), the process proceeds to step S13 described later.

In a case where the switching to the manual control is selected by the driver, the control to move to the initial stop position is not performed, and thus, the storage of the recognition result and the storage of the route are deleted. Thereafter, it is determined that the start has been completed, and the travel assistance is finished.

On the other hand, in a case where the switching to the manual control is not desired by the driver, the vehicle control unit 16 performs the autonomous movement control to the initial position in step S13.

### Movement Control to Initial Stop Position

The flowchart of FIG. 7 illustrates details of the processing contents in step S13 of FIG. 6.

First, in steps S13a and S13b, the vehicle control unit 16 acquires information accumulated in the detection result storage unit 12 and the route storage unit 15 while the host vehicle 1 moves on the forward route (arrow A1) from the initial position to the stop position.

Next, in step S13c, the vehicle control unit 16 controls the brake ECU 40, the steering ECU 50, and the shift ECU 60 so as to follow the information of the route (arrow A1) accumulated in the route storage unit 15, thereby causing the host vehicle 1 to start traveling on the backward route (arrow A2).

In step S13d, the vehicle control unit 16 acquires a sensing result detected by the external sensor 21 while the vehicle is traveling on the backward route.

In step S13e, the vehicle control unit 16 compares the sensing result in the backward route (arrow A2) acquired in step S13d with the sensing result detected by the external sensor 21 during traveling in the forward route (arrow A1) stored in the detection result storage unit 12, and determines whether there is a certain or more change (for example, 10% or more) in the surrounding situation. Then, if there is a change equal to or more than a certain level, the process proceeds to step S13i, and if there is no change equal to or more than a certain level, the process proceeds to step S13f.

In a case where there is a certain level or more of environmental change after the start of the host vehicle 1 (for example, in a case as illustrated in the upper right diagram of FIG. 5), it is determined that safe autonomous movement is difficult, and thus the vehicle control unit 16 stops the autonomous traveling control in step S13i. After the autonomous traveling control is stopped, the storage of the detection result and the storage of the route unnecessary for the subsequent control are deleted in steps S13j and S13k. In this case, the driver manually controls the travel of the host vehicle 1 according to the environmental change.

On the other hand, in a case where the environmental change after the start of the host vehicle 1 is less than the certain level, in step S13f, the vehicle control unit 16 determines that the safe surrounding environment is maintained, and continues the autonomous traveling control until the host vehicle 1 reaches the initial position.

In step S13g, the initial stop position determination unit 13 determines whether the current position of the host vehicle 1 is the initial stop position (starting point of the forward route). Then, if the current position of the host vehicle 1 is the initial stop position, the process proceeds to step S13h, and if the host vehicle 1 has not reached the initial stop position, the process returns to step S13d.

In a case where it is determined that the current position of the host vehicle 1 is the initial stop position, in step S13h, the vehicle control unit 16 determines that the autonomous traveling control for returning on the backward route is completed, and transmits necessary information to each of the meter ECU 30, the brake ECU 40, the steering ECU 50, and the shift ECU 60.

After the host vehicle 1 stops, steps S13j and S13k are performed. As a result, it is possible to wait for the moving object 2 to pass at a safe position.

In a case where the autonomous traveling control is interrupted in step S13i, or in a case where the autonomous traveling control is completed in step S13h, the shift of the host vehicle 1 is put into neutral or parking to bring the host vehicle 1 into a safe state.

According to the present embodiment described above, it is possible to safely and autonomously move the host vehicle from a position that hinders the traveling of the other moving object to a position that does not hinder the traveling of the other moving object on the basis of a simpler determination than the determination of the possibility of collision.

### Second Embodiment

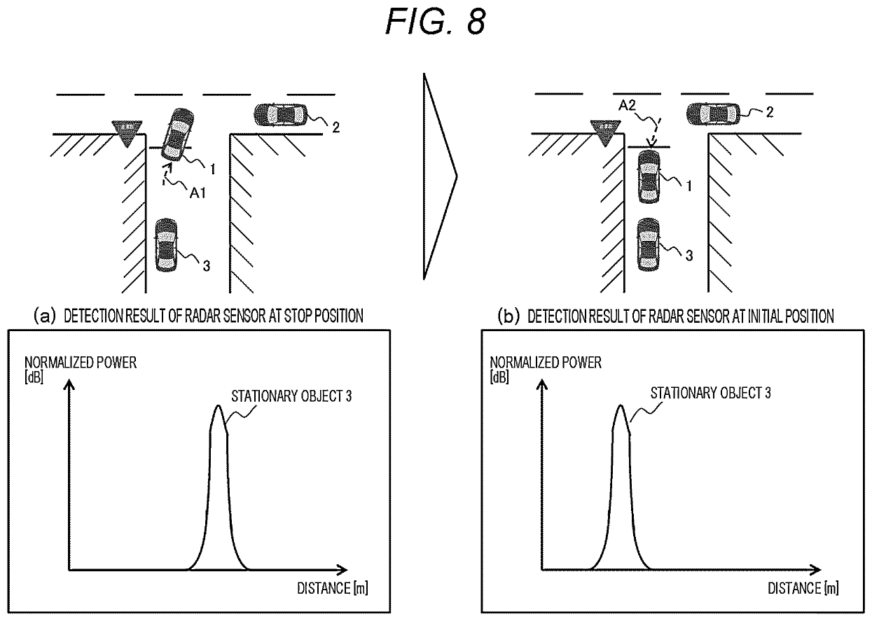

Next, a second embodiment of the present invention will be described with reference to FIG. 8. Redundant description of common points with the first embodiment will be omitted.

In the first embodiment, a situation has been assumed in which the moving object 2 is recognized while the host vehicle 1 is exiting the parking slot, the brake is operated, and then the host vehicle 1 autonomously moves on the backward route (arrow A2) to the initial position. On the other hand, the present embodiment assumes a situation where the host vehicle 1 that has entered an intersection or a T-junction autonomously moves on a backward route to an initial position after operating the brake on the moving object 2 that the host vehicle 1 crosses.

A travel assistance device at an intersection and a T-junction will be described with reference to FIG. 8. Note that the present invention can be applied to not only an intersection and a T-junction as illustrated in FIG. 8 but also a case where there is a large sidewalk or a bicycle lane to a roadway.

The upper left diagram of FIG. 8 illustrates a situation where the host vehicle 1 that has stopped immediately before the stop line is about to enter the intersection while slowly traveling, and a position where the host vehicle 1 has stopped before starting is defined as an initial position. The moving object 2 is a vehicle approaching from the right direction of the host vehicle 1 while traveling on the priority road, and the stationary object 3 is a stopped vehicle temporarily stopping on the rear side of the host vehicle 1. Note that the moving object 2 may be a cyclist, a pedestrian, or the like. Although the start of the host vehicle 1 occurs when the host vehicle 1 attempts to turn right, a case where the host vehicle 1 goes straight or turns left is also within the scope of the present invention.

As illustrated in the upper left diagram of FIG. 8, when the host vehicle 1 stops on the route of the moving object 2 as a result of recognizing the moving object 2 that the host vehicle 1 approaches from the right direction by the external sensor 21 or the driver and operating the automatic brake or the manual brake, it is necessary to move the host vehicle 1 backward to a position that does not become a traveling obstruction of the moving object 2 traveling on the priority road.

Therefore, vehicle control is executed in which the host vehicle 1 that has moved toward the front side along the route of the arrow A1 is autonomously moved to the initial position along the route of the arrow A2. The control to move to the initial stop position is performed on the basis of the output result of the external sensor 21 from the initial stop position to the timing when the brake is operated and the stored information of the output results of the steering angle sensor 22 and the wheel speed sensor 23. That is, even under the situation of FIG. 8, appropriate control can be executed by the procedure of the flowcharts of FIGS. 6 and 7.

Note that the present invention is not limited to the above-described embodiments, and includes various modifications. For example, the above-described embodiments have been described in detail for easy understanding of the present invention, and are not necessarily limited to those having all the described configurations. In addition, some or all of the above-described configurations, functions, processing units, processing means, and the like may be realized by hardware, for example, by designing with an integrated circuit. In addition, each of the above-described configurations, functions, and the like may be realized by software by a processor interpreting and executing a program for realizing each function. Information such as a program, a table, and a file for realizing each function can be stored in a recording medium such as a memory, a hard disk, and a solid state drive (SSD), or a recording medium such as an IC card, an SD card, and a DVD.

### REFERENCE SIGNS LIST

1 host vehicle
2, 2a moving object
3 stationary object
10 travel assistance device
11 detection result processing unit
12 detection result storage unit
13 initial stop position determination unit
14 moving object recognition unit
15 route storage unit
16 vehicle control unit
17 shift change control unit
21 external sensor
22 steering angle sensor
23 wheel speed sensor
24 shift sensor
30 meter ECU
31 display device
32 speaker
40 brake ECU
41 brake actuator
42 MC pressure
50 steering ECU
51 steering actuator
60 shift ECU
61 shift actuator

1. A travel assistance device comprising:
a detection result storage unit that stores a detection result of an external sensor installed in a host vehicle;
a moving object recognition unit that recognizes a surrounding moving object based on a detection result of the external sensor;
a route storage unit that stores a route along which the host vehicle has moved based on vehicle information acquired by a vehicle sensor installed in the host vehicle;
an initial stop position determination unit that determines an initial position at which the host vehicle has stopped before starting, based on the detection result stored in the detection result storage unit; and
a vehicle control unit that stops the host vehicle based on a recognition result of the moving object recognition unit after the host vehicle starts from the initial position, wherein
the detection result storage unit stores at least the initial position and the detection result on the route, and
the vehicle control unit controls movement on the route from a stop position where the host vehicle is stopped to the initial position based on a detection result of the external sensor at a current position of the host vehicle and a detection result of the external sensor stored in the detection result storage unit.

2. The travel assistance device according to claim 1, wherein
the vehicle control unit continues movement on the route from a stop position where the host vehicle is stopped to the initial position in a case where a matching degree between a detection result of the external sensor at a current position of the host vehicle and a detection result of the external sensor stored in the detection result storage unit exceeds a threshold.

3. The travel assistance device according to claim 1, wherein
the vehicle control unit stops movement on the route from a stop position where the host vehicle is stopped to the initial position in a case where a matching degree between a detection result of the external sensor at a current position of the host vehicle and a detection result of the external sensor stored in the detection result storage unit is less than a threshold.

4. The travel assistance device according to claim 1, comprising:
a notification unit that issues a notification for prompting switching from automatic control by the host vehicle to manual control by a driver after the host vehicle stops at the stop position; and
a control change unit that switches from the automatic control by the host vehicle to the manual control by the driver based on a switching instruction by the driver.

5. A travel assistance method comprising:
a step (a) of recognizing a surrounding moving object based on a detection result of an external sensor installed in a host vehicle;
a step (b) of storing a detection result of the external sensor;
a step (c) of storing a route along which the host vehicle has moved based on vehicle information acquired by a vehicle sensor installed in the host vehicle;
a step (d) of determining an initial position at which the host vehicle has stopped before starting based on the stored detection result; and
a step (e) of stopping the host vehicle based on the recognition result after the host vehicle starts from the initial position, wherein
in the step (b), at least the initial position and the detection result in the route are stored, and
in the step (e), movement on the route from a stop position at which the host vehicle is stopped to the initial position is controlled based on a detection result of the external sensor at a current position of the host vehicle and a stored detection result of the external sensor.
